(19) United States
(12) Patent Application Publication
(10) Pub. No.: US 2017/0018760 A1
(43) Pub. Date: Jan. 19, 2017

(54) Active Cathode Material for Secondary Lithium Cells and Batteries

(71) Applicant: Bayerische Motoren Werke Aktiengesellschaft, Muenchen (DE)

(72) Inventors: Saskia LUPART, Muenchen (DE); Thomas WOEHRLE, Muenchen (DE)

(21) Appl. No.: 15/279,531

(22) Filed: Sep. 29, 2016

Related U.S. Application Data
(63) Continuation of application No. PCT/EP2015/056244, filed on Mar. 24, 2015.

(30) Foreign Application Priority Data
Mar. 31, 2014 (DE) 10 2014 205 945.3

(51) Int. Cl. H01M 4/131; H01M 4/1391; H01M 10/0525; H01M 4/505; H01M 4/62; H01M 4/04; H01M 4/525

(52) U.S. Cl. CPC H01M 4/131; H01M 4/0428; H01M 4/0423; H01M 4/1391; H01M 4/525; H01M 4/505; H01M 4/623; H01M 4/622; H01M 4/625; H01M 10/0525

(57) ABSTRACT

A cathode material, and a method of producing same, includes particles made of lithium metal oxide having a coating, wherein the coating consists of a solid lithium ion conductor having a granite-like crystal structure and has been deposited onto the lithium metal oxide by a physical process. The cathode material is used in an electrode and in an electrochemical apparatus.

### CROSS REFERENCE TO RELATED APPLICATIONS

This application is a continuation of PCT International Application No. PCT/EP2015/056244, filed Mar. 24, 2015, which claims priority under 35 U.S.C. §119 from German Patent Application No. 10 2014 205 945.3, filed Mar. 31, 2014, the entire disclosures of which are herein expressly incorporated by reference.

### BACKGROUND AND SUMMARY OF THE INVENTION

The present invention relates to a cathode material for secondary lithium cells, or batteries. The invention additionally relates to a positive electrode and an electrochemical apparatus comprising the cathode material and also a process for producing the cathode material.

The term battery refers to at least two connected cells. In the present description, the terms cell and battery will be used synonymously.

An example of secondary lithium batteries are lithium ion batteries. In this battery system, the electrical energy is stored by means of lithium ions (at the negative electrode) and (usually) transition metal oxides (at the positive electrode) in a chemical process involving intercalation processes. In lithium ion batteries, lithium can migrate back and forth in ionized form through the electrolyte between the two electrodes. In contrast to the lithium ions, the transition metal ions present at the cathode are fixed in place and do not change their structure during intercalation and deintercalation.

This lithium ion flow is necessary to balance the external current flow during charging and discharging, so that the electrodes themselves remain (largely) electrically neutral. During discharging, lithium atoms each release an electron at the negative electrode and this electron flows via the external current circuit to the positive electrode. At the same time, the same number of lithium ions migrate through the electrolyte from the negative electrode (anode) to the positive electrode (cathode). At the positive electrode, however, the electron is not taken up again by the lithium ions but instead by the transition metal ions which are present there and are strongly ionized in the charged state. In lithium ion systems, these can be cobalt, nickel, manganese, iron ions, etc. The lithium thus continues to be present in ionic form at the positive electrode in the discharged state.

The cathode materials used at present in secondary lithium batteries represent a bottleneck in lithium ion technology in respect of the costs and capacity of the battery. In view of this background, the search for a new generation of cathode materials which make cathodes having an increased capacity, good rate capability, high working voltage and also a long and reliable cycling life possible, particularly for operation in cells having large dimensions, is indispensable.

CN 102738451 A discloses a cathode material for lithium batteries, in which the active cathode material was coated with a fast lithium ion conductor having a garnet-type crystal structure by means of a sol-gel process with subsequent sintering.

Sébastien Patoux et al., “High voltage spinel oxides for lithium batteries: From the material research to the application”, Journal of Power Sources—J POWER SOURCES, vol. 189 (2009), No. 1, pages 344-352, discloses high-voltage spinel oxides (HV spinels) for lithium ion batteries which have the general composition LiMn₂₋ₓMₓO₄, where M is a transition metal element.

J. Liu, A. Manthiram, Journal of the Electrochemical Society 156, S13, 2009 and J. Liu and A. Manthiram, Chem. Mater. 21, 1695, 2009, disclose cathode materials composed of Al₂O₃-coated HV spinels.

It is an object of the present invention to provide a cathode material for lithium ion batteries having improved life, energy density, stability and power. A further object is to provide an electrode and an electrochemical device comprising the cathode material and also a process for producing the cathode material.

The above object is achieved by a cathode material comprising particles of lithium-metal oxide having a coating, wherein the coating consists of a fast lithium ion conductor having a garnet-type crystal structure and has been deposited by a physical process on the lithium-metal oxide. In the present description, the term lithium-metal oxide refers to all compounds which are suitable for active cathode materials and include lithium together with at least one further metal selected from the group of the transition metals and also oxygen. A coating produced in this way differs structurally from coatings which have been deposited by sol-gel processes and subsequently sintered in terms of the lower roughness and more closed nature of the coating. This difference can be confirmed by electron transmission microscopy (cf., for example, electron transmission micrographs for LiCoO₂ coated with ZrO₂ by sol-gel processes in: Chen, Z. H. and Dahn J. R., Solid-State Lett., 2002, 5, A213-A216).

Suitable fast lithium ion conductors having a garnet-type crystal structure are those described in DE 102007030604 A1 and DE 102004010892 B3. For example, Li₅La₃M₂O₁₂ (M=Ta, Nb) or Li₆ALa₂M₂O₁₂ (A=Ca, Sr, Ba; M=Ta, Nb) can be used as fast lithium ion conductor having a garnet-type crystal structure.

The use of the cathode material of the invention in a lithium ion battery enables the decomposition of liquid electrolytes (for example 1M lithium hexafluoro-phosphate (LiPF₆) in a mixture of the organic solvents ethylene carbonate (EC) and ethyl methyl carbonate (EMC)) in the potential range from 4.2 V to 4.3 V to be significantly reduced and the life of the lithium battery thus to be increased.

The physical deposition process is preferably selected from the group consisting of atomic layer deposition (ALD), plasma-enhanced chemical vapor deposition (PECVD) and pulsed laser deposition (PLD). Greater preference is given to pulsed laser deposition and atomic layer deposition. Atomic layer deposition is particularly preferred.

Plasma-enhanced chemical vapor deposition is a particular form of chemical vapor deposition (CVD) in which the chemical deposition is assisted by a plasma. The plasma can burn directly at the substrate to be coated (direct plasma method) or in a separate chamber (remote plasma method).

During CVD, dissociation (breaking-up) of the molecules of the reaction gas occurs as a result of introduction of external heat and the energy released by the subsequent chemical reactions; this task is performed by accelerated electrons in the plasma in the case of PECVD. In addition to the free radicals formed in this way, ions are also generated in a plasma and together with the free radicals bring about deposition of the layer on the substrate. The gas temperature in the plasma is generally increased by only a few hundred degrees Celsius, as a result of which relatively temperature-sensitive materials can also be coated, in contrast to CVD.

In the direct plasma method, a strong electric field is applied between the substrate to be coated and a counterelectrode, as a result of which a plasma is ignited. In the remote plasma method, the plasma is arranged in such a way that it has no direct contact with the substrate. This gives advantages in respect of selective excitation of individual components of a process gas mixture and reduces the possibility of plasma damage to the substrate surface by the ions. Possible disadvantages are the loss of free radicals along the path between remote plasma and substrate and the possibility of gas-phase reactions before the reactive gas molecules have reached the substrate surface.

The plasmas can also be generated inductively/capacitively by injection of an alternating electromagnetic field, which makes electrodes superfluous.

Pulsed laser deposition is a physical vapor deposition process (PVD process) and closely related to thermal vaporization. This term describes the deposition of layers by laser ablation. For this purpose, both the layer material to be deposited (target) and the substrate on which the layer is to be deposited (substrate) are placed in a vacuum container (recipient).

The material of the target is illuminated in a vacuum chamber by high-intensity pulsed laser radiation (≈10 MW/cm²) and thereby vaporized. The vaporization process for the target material is effected here via absorption of the energy of the laser beam by the material to be vaporized. Above a particular (sufficient) quantity of energy, a plasma is formed at the target, as a result of which atoms can become detached from the target. When high process gas pressures (>1 mbar) are used, condensation of the vapor of material in the gas phase to form clusters (groups of atoms) is possible. This vapor of material moves through the vacuum chamber away from the target to the substrate and condenses there to form a thin layer. To produce crystalline layers, the substrate is additionally heated to make diffusion processes and thus rearrangement of the atoms possible. In this way, other particles can also be built into the crystal, either in order to produce more complex materials or to effect doping.

Particularly good results are achieved using UV lasers (e.g. XeCl or KrF excimer laser) since the radiation of these has a high photon energy which is absorbed by many materials since it is above the plasma frequency. Further pulsed lasers for PLD are transversally excited CO₂ lasers, Q-switched Nd:YAG lasers and increasingly also pulsed femtosecond lasers. The pulse length is typically in the range 10-50 ns at a repetition frequency of a few hertz.

To deposit fast lithium ion conductors having a garnet-type crystal structure, it is possible to use, for example, an experimental setup as described in Katherine A. Sloyan et al., “Growth of crystalline garnet mixed films, superlattices and multilayers for optical applications via shuttered combinatorial pulsed laser deposition”, Optics Express, vol. 18, number 24, pages 24679-24687 (2010).

Atomic layer deposition is a greatly modified CVD process for the deposition of thin layers by means of two or more self-limiting surface reactions which are carried out cyclically. As in other CVD processes, layer formation in ALD is also achieved by means of a chemical reaction between at least two starting materials (precursors). In contrast to conventional CVD processes, the starting materials are introduced cyclically in succession into the reaction chamber in ALD. Between the gas introductions of the starting materials, the reaction chamber is normally flushed with an inert gas (e.g. argon). This is intended to separate the subreactions clearly from one another and limit them to the surface. A main feature of ALD is the self-limiting character of the subreactions, i.e. the starting material of one subreaction does not react with itself or ligands of itself, which limits the layer growth of a subreaction for any length of time and any amount of gas to not more than one monolayer per cycle.

The cycle has to be repeated a number of times during the course of the coating process in order to achieve the desired layer thickness. In the ideal case, each reaction step proceeds to completion, i.e. the precursor molecules chemisorb or react with the surface groups until the surface is completely covered. After this, no further adsorption takes place (self-limitation). Under these reaction conditions, layer growth is self-controlling or self-limiting, i.e. the amount of the layer material deposited in each reaction cycle is constant.

Depending on the process and reactor, a cycle takes from 0.5 to a few seconds, with from 0.1 to 3 Å of film material being produced per cycle (greatly dependent on the materials system and the process parameters). In reality, however, the spatial expansion of the starting substrates (steric hindrance) and incomplete subreactions leads to a closed layer of the intended material not being able to be achieved by means of one cycle.

Despite the nonideal growth in real processes, a number of advantages are obtained in the deposition of thin layers by means of atomic layer deposition. One important point is the very good layer thickness control of ultrathin layers having a thickness of less than 10 nm. This is because, as a result of the abovementioned self-limiting reaction, the growth of the layer per cycle is limited to a determinable value which in the saturation range is independent of the cycle time. The layer grows proportionally to the number of reaction cycles, which allows precise control of the layer thickness. In addition, the separate introduction of the precursor substances prevents undesirable gas-phase reactions in the sample space and also allows the use of highly reactive precursors. Due to the fixed introduction, each reaction step has enough time to proceed to completion; this makes high-purity layers possible even at relatively low temperatures.

The molar ratio of the coating to the lithium-metal oxide is preferably not more than 0.01. This makes it possible to improve, compared to a conventional coating, the energy density, specific energy, the high-current capability of the cell (since the coating is an electrical insulator) and at the same time reduce the costs. In addition, a proportion of greater than 0.1 results in a worsening of the electrical conductivity, i.e. the lithium-metal oxide particle is electrically insulated since the coating is only ionically conductive but not electrically conductive; this leads to a decrease in the performance of the electrode or cell.

The coating preferably has a thickness of from 10 to 100 nm, more preferably 20-50 nm.

The coating is preferably enveloping and closed. The coating is particularly preferably free of pinholes. In this way, direct contact of the electrolyte with the active cathode material, i.e. the lithium-metal oxide, can be avoided, so that the undesirable decomposition of the electrolyte during operation of the electrochemical cell is reduced and the life of the electrochemical cell can thus be increased.

In a preferred embodiment, the lithium-metal oxide has a spinel crystal structure. For example, lithium-manganese spinel (LiMn₂O₄) of the spinel structure type can be used. Preference is given to using doped or undoped HV spinels. Particular preference is given to HV spinels having the general composition LiMn₂₋ₓMₓO₄, where M is a transition metal element and x can, depending on the transition metal element, assume various values in the range from 0 to 2. For example, the HV spinel LiMn_{1.5}Ni_{0.5}O₄ can be used. Such materials are disclosed, for example, in Sébastien Patoux et al., “High voltage spinel oxides for Li-ion batteries: From the material research to the application”, Journal of Power Sources—J Power Sources, vol. 189 (2009), No. 1, pages 344-352.

In a further preferred embodiment, the layer includes lithium-metal oxide of the general formula xLiMO₂(1-x)Li₂M′O₃ where 0<x<1 and M is at least one metal having the average oxidation state of three and comprising at least nickel and M′ is at least one ion having the average oxidation state of four and comprising at least manganese. Such materials are, for example, disclosed in Michael M. Thackeray et al., Journal of Materials Chemistry, J MATER CHEM, 2007, 17, 3112-3125.

In a preferred embodiment, the lithium-metal oxide is a coated Ni oxide having the alpha-NaCrO₂ structure and an Ni content of at least 30%. Such materials are disclosed, for example, in EP 0017400B1 (Goodenough, J. B. et al.).

In a preferred embodiment, the lithium-metal oxide is an LiMSiO₄, where M is a metal selected from the group consisting of Fe, Mn, Ni, Co and mixtures thereof. Such materials are described, for example, in Zhou F., Cococcioni M., Kang K., Ceder G.; “The Li intercalation potential of LiMPO₄ and LiMSiO₄ olivines with M=Fe, Mn, Co, Ni”; [J]. Electrochemistry Communications, 2004, 6: 1144-1148.

In a preferred embodiment, the lithium-metal oxide has an olivine structure. Preference is given to using a material having the general formula LiMPO₄, where M is a divalent metal selected from the group consisting of Fe²⁺, Mn²⁺, Co²⁺ and mixtures thereof. Particular preference is given to LiMnO₄. These materials are described, for example, in Zhumabay Bakenov and Izumi Taniguchi, “LiMnPO₄ olivine as a cathode for lithium batteries”, The Open Materials Science Journal, 2011, 5, (Suppl. 1: M4) 222-227.

The weight average particle size d50 of the particles of lithium-metal oxide is preferably 0.1-30 μm, preferably 0.5-20 μm.

In a second aspect, the present invention provides an electrode including the above cathode material and a current collector. For example, rolled aluminum foil can be used as current collector. The electrode preferably further comprises binders and an electrically conductive additive. The electrically conductive additive can comprise carbon. Preference is given to using carbon fibers, carbon black or a mixture thereof. Particular preference is given to conductive carbon black, e.g. Super P from Timcal.

In a third aspect, the present invention provides an electrochemical device including an electrode as described above as positive electrode, an ion-conducting medium and a negative electrode. The device is preferably configured as a battery.

In a third aspect, the present invention provides a process for producing the cathode material, wherein particles of lithium-metal oxide having a coating composed of a solid lithium ion conductor having a garnet-type crystal structure are deposited by a physical process on the lithium-metal oxide. The physical deposition process is preferably selected from the group consisting of atomic layer deposition (ALD), plasma-enhanced chemical vapor deposition (PECVD) and pulsed laser deposition (PLD). Atomic layer deposition is particularly preferred.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic drawing of a particle of lithium-metal oxide (1) having a coating comprising a fast lithium ion conductor of the garnet-type crystal structure type (2), where the coating has been deposited by a sol-gel process (prior art) and subsequently sintered.

FIG. 2 is a schematic drawing of a particle of lithium-metal oxide (1) having a coating comprising a fast lithium ion conductor of the garnet-type crystal structure type (2), where the coating has been deposited by a physical process.

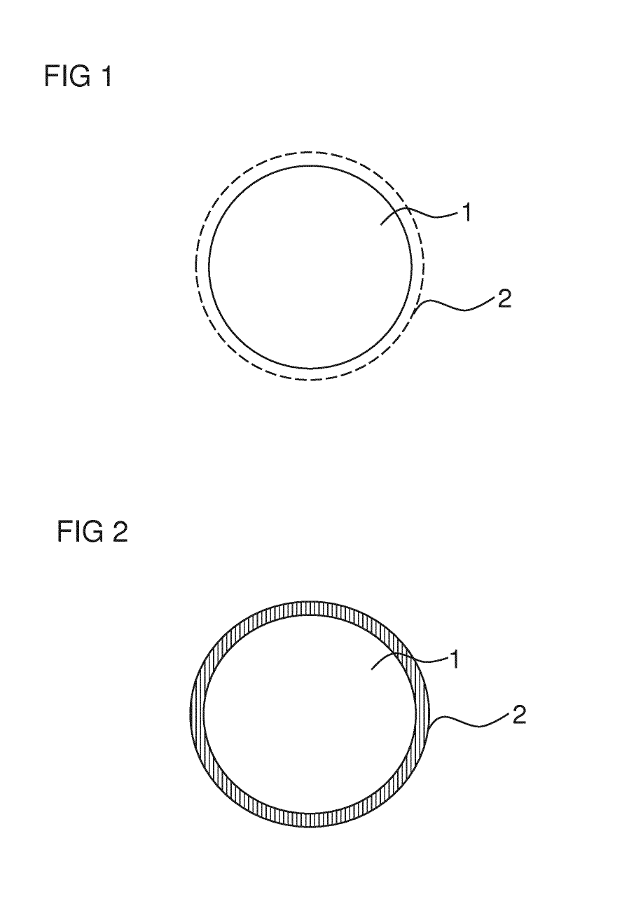

### DETAILED DESCRIPTION OF THE DRAWINGS

In one embodiment, the cathode protective layer is deposited by means of PLD on HV spinel (LiMn_{1.5}Ni_{0.5}O₄) particles having a weight average particle size d50 of 10 μm. A garnet-type compound produced by standard sol-gel methods is used as target. The synthesis conditions during the deposition process take place under an O₂ atmosphere having an oxygen pressure in the range from 1 to 10 Pa.

The coating is examined by imaging methods in order to ensure that the coating is not a “rough” coating in which the surface of the active material is not completely covered. A suitable method for this purpose is, for example, SEM (scanning electron microscopy). To analyze the composition of the protective layer, an elemental analysis of the surface (XPS) is carried out. As an alternative, it is also possible to use other structure analysis methods such as X-ray powder diffraction.

XRR analysis (X-ray reflectometry) can be used to analyze the thickness.

Laboratory cells having a nominal capacity of 40 mAh for long-term cycling and having the following structure are constructed: aluminum composite film as packaging material (from Showa, JP); Hitachi SMG A3 synthetic graphite, Celgard 25 μm separator PP/PE/PP (type 2335) having the side facing the cathode coated with 3 μm of Al₂O₃/PVdF-HFP (80:20 w/w), PVdF (cathode binder), CMC/SBR (anode binder). Liquid electrolyte: 1 M LiPF₆ in EC:DEC (3/7, v/v).

Variants:

a) Reference cell comprising HV spinel (LiMn_{1.5}Ni_{0.5}O₄) without garnet solid-state coating.

b) Cell comprising HV spinel (LiMn_{1.5}Ni_{0.5}O₄) with Al₂O₃ coating as per the prior art.

c) Cell comprising HV spinel (LiMn_{1.5}Ni_{0.5}O₄) with garnet solid-state coating according to the invention.

TABLE 1
Results of long-term cycling at room temperature
(1 C charge, 1 C discharge)

| | Cycles until 80% | |
|---|---|---|
| | residual capacity | |
| | of the nominal | |
| | capacity has | |
| | been reached. | |
| Cell variant | 1 C cycling | Comment |
| a: without any protective | 300 | Particle surface without |
| layer. | | protection |
| b: protective layer as per | 400 | Surface - |
| the prior art. | | Surface with protection |
| | | but without Li conductor |
| | | function |
| c: protective layer | 450 | Surface - |
| according to the invention | | Surface with protection |
| | | and with Li conductor |
| | | function |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cathode material comprising particles of lithium-metal oxide having a coating, wherein the coating consists of a solid lithium ion conductor having a garnet-type crystal structure and has been deposited by a physical process on the lithium-metal oxide.

2. The cathode material as claimed in claim 1, wherein the physical deposition process is selected from the group consisting of: atomic layer deposition (ALD), plasma-enhanced chemical vapor deposition (PECVD) and pulsed laser deposition (PLD).

3. The cathode material as claimed in claim 1, wherein a molar ratio of the coating to the lithium-metal oxide is not more than 0.01.

4. The cathode material as claimed in claim 1, wherein the coating has a thickness of from 10 to 100 nm.

5. The cathode material as claimed in claim 4, wherein the coating has a thickness of from 20-50 nm.

6. The cathode material as claimed in claim 1, wherein the coating is enveloping and closed.

7. The cathode material as claimed in claim 1, wherein the lithium-metal oxide has a spinel crystal structure.

8. The cathode material as claimed in claim 1, wherein the lithium-metal oxide is of the general formula xLiMO₂(1-x)Li₂M′O₃ where 0<x<1 and M is at least one metal having the average oxidation state of three and comprising at least nickel and M′ is at least one ion having the average oxidation state of four and comprising at least manganese.

9. The cathode material as claimed in claim 1, wherein the lithium-metal oxide is a coated Ni oxide having the alpha-NaCrO₂ structure and an Ni content of at least 30%.

10. The cathode material as claimed in claim 1, wherein the lithium-metal oxide is an LiMSiO₄, where M is a metal selected from the group consisting of Fe, Mn, Ni, Co and mixtures thereof.

11. The cathode material as claimed in claim 1, wherein the lithium-metal oxide has an olivine crystal structure.

12. The cathode material as claimed in claim 1, wherein the size of the particles of lithium-metal oxide is 0.1-30 μm.

13. The cathode material as claimed in claim 12, wherein the size of the particles of lithium-metal oxide is 0.5-20 μm.

14. An electrode, comprising the cathode material as claimed in claim 1 and a current collector.

15. The electrode as claimed in claim 14, wherein the electrode further comprises binders and a conductive additive.

16. An electrochemical device, comprising the electrode as claimed in claim 14 as a positive electrode, an ion-conducting medium and a negative electrode.

17. An electrochemical device, comprising the electrode as claimed in claim 15 as positive electrode, an ion-conducting medium and a negative electrode.

18. The electrochemical device as claimed in claim 16, wherein the device is configured as a battery.

19. A process for producing a cathode material, wherein particles of lithium-metal oxide having a coating composed of a solid lithium ion conductor having a garnet-type crystal structure are deposited by a physical deposition process on the lithium-metal oxide.

20. The process as claimed in claim 19, wherein the physical deposition process is selected from the group consisting of:
atomic layer deposition (ALD), plasma-enhanced chemical vapor deposition (PECVD) and pulsed laser deposition (PLD).
